(19) United States
(12) Patent Application Publication
(10) Pub. No.: US 2024/0213827 A1
(43) Pub. Date: Jun. 27, 2024

(54) LAMINATED CORE AND METHOD FOR MANUFACTURING LAMINATED CORE

(71) Applicant: Nidec Corporation, Kyoto (JP)

(72) Inventors: Takeshi HONDA, Kyoto (JP); Hitoshi KATSURADA, Kyoto (JP); Yoshito NAGANO, Kyoto (JP)

(21) Appl. No.: 18/390,427

(22) Filed: Dec. 20, 2023

(30) Foreign Application Priority Data
Dec. 27, 2022 (JP) 2022-210405

(51) Int. Cl. H02K 1/16; H02K 15/02

(52) U.S. Cl. CPC H02K 1/16; H02K 15/024

(57) ABSTRACT

A laminated core is tubular and includes a back yoke portion and tooth portions. The back yoke portion includes a cut line between the tooth portions adjacent to each other in a circumferential direction, the cut line extending in a radial direction from an inner peripheral surface. When one of back yoke portions adjacent to each other in a stacking direction is referred to as a first back yoke portion and the other is referred to as a second back yoke portion, at least a portion of the cut line in the first back yoke portion does not overlap the cut line in the second back yoke portion when the back yoke portion is viewed from the stacking direction. The first back yoke portion is at least partially bonded to the second back yoke portion.

### CROSS-REFERENCE TO RELATED APPLICATIONS

The present application claims priority under 35 U.S.C. § 119 to Japanese Patent Application No. 2022-210405, filed on Dec. 27, 2022, the entire contents of which are hereby incorporated herein by reference.

### 1. FIELD OF THE INVENTION

The present disclosure relates to a laminated core and a method for manufacturing a laminated core.

### 2. BACKGROUND

A laminated core is known in which back yoke portions are laminated, the back yoke portions each being formed in an annular shape by bending a core piece in a strip shape extending in one direction. For example, a stator core including a straight core of a motor is conventionally known in which the straight core is formed by not only stacking a plurality of punched plates each having a cut portion in a substantially V-shape provided between adjacent teeth in a back yoke and on a side where the teeth protrude, but also bending each of the punched plates at the cut portion to form the straight core in an arc shape or a ring shape.

The conventional back yoke portion is obtained by closing a gap of the cut portion in a V-shape and plastically deforming its outer periphery in an arc shape. The back yoke portion bent in an arc shape by plastic deformation may cause spring back in which a deformed part tries to return to a state before deformation. As a result, the cut portion may be opened to deteriorate dimensional accuracy of the laminated core. Thus, a laminated core in which a back yoke portion has a cut line with a closed gap requires a configuration capable of suppressing deterioration in dimensional accuracy.

### SUMMARY

A laminated core according to an example embodiment of the present disclosure is a laminated core in a tubular shape including a back yoke portion in a plate shape extending in a circumferential direction, and tooth portions in a plate shape protruding radially inward from the back yoke portion, the back yoke portion and the tooth portions being stacked in a thickness direction of the laminated core to extend along an axis of the laminated core. The back yoke portion includes a cut line between ones of the tooth portions adjacent to each other in the circumferential direction, the cut line extending in a radial direction from an inner peripheral surface. When one of two back yoke portions adjacent to each other in a stacking direction is referred as a first back yoke portion and another one of the two back yoke portions adjacent to each other in the stacking direction is referred as a second back yoke portion, at least a portion of the cut line in the first back yoke portion is located at a position not overlapping the cut line in the second back yoke portion when the back yoke portion is viewed from the stacking direction. The first back yoke portion is at least partially bonded to the second back yoke portion.

A method for manufacturing a laminated core according to an example embodiment of the present disclosure is a method for manufacturing a laminated core in which a back yoke portion in a plate shape and tooth portions in a plate shape are stacked in a thickness direction of the laminated core. The method for manufacturing the laminated core includes a punching step of punching a steel plate to form a back yoke forming portion extending in a first direction, the tooth portions extending from the back yoke forming portion toward one side in a second direction intersecting the first direction when the steel plate is viewed in its thickness direction, and a slit extending toward the other side in the second direction between ones of the tooth portions adjacent to each other in the first direction in the back yoke forming portion, a back yoke bending step of forming the back yoke portion by bending the back yoke forming portion in an arc shape by closing a gap of the slit when the back yoke forming portion formed in the punching step is viewed in the thickness direction, and a stacking step of bonding the back yoke portion bent in an arc shape in the back yoke bending step while the back yoke portions are stacked in a stacking direction. The punching step is performed to form the slit at a first position in one of two of the back yoke portions adjacent to each other in the stacking direction and form the slit at a second position in another one of the back yoke portions, the first position being different from the second position.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view illustrating a schematic configuration of a laminated core according to a first example embodiment of the present disclosure.

FIG. 2 is a plan view illustrating a schematic configuration of a laminated core according to an example embodiment of the present disclosure.

FIG. 3 is a plan view illustrating a schematic configuration of a core piece stacked in a laminated core according to an example embodiment of the present disclosure.

FIG. 4 is a partially enlarged view of FIG. 2.

FIG. 5 is an enlarged view of a cut line according to an example embodiment of the present disclosure.

FIG. 6 is a view illustrating a positional relationship of cut lines in back yoke portions adjacent to each other in a stacking direction according to an example embodiment of the present disclosure.

FIG. 7 is a view illustrating an example of a position where back yoke portions adjacent to each other in a stacking direction are bonded according to an example embodiment of the present disclosure.

FIG. 8 is a view illustrating an example of a position where back yoke portions adjacent to each other in a stacking direction are bonded according to an example embodiment of the present disclosure.

FIG. 9 is a flowchart illustrating a method for manufacturing the laminated core according to the first example embodiment of the present disclosure.

FIG. 10 is a diagram illustrating a punched steel plate according to an example embodiment of the present disclosure.

FIG. 11 is a plan view of a back yoke forming portion and a plurality of teeth punched out from a steel plate according to an example embodiment of the present disclosure.

FIG. 12 is a diagram illustrating a method for bending a back yoke forming portion punched out from a steel plate according to an example embodiment of the present disclosure.

FIG. 13 is a partial plan view illustrating a schematic configuration of a laminated core according to a second example embodiment of the present disclosure.

FIG. 14 is a partial plan view illustrating a schematic configuration of a core piece stacked in a laminated core according to an example embodiment of the present disclosure.

FIG. 15 is an enlarged view of an outer-peripheral-side recess according to an example embodiment of the present disclosure.

FIG. 16 is a diagram illustrating a schematic configuration of a laminated core according to a third example embodiment of the present disclosure.

FIG. 17 is a diagram illustrating an example of placement of slits according to an example embodiment of the present disclosure.

FIG. 18 is a diagram illustrating another example of placement of slits according to an example embodiment of the present disclosure.

FIG. 19 is a diagram illustrating a schematic configuration of a laminated core according to a fourth example embodiment of the present disclosure.

FIG. 20 is a flowchart illustrating a method for manufacturing the laminated core according to the fourth example embodiment of the present disclosure.

### DETAILED DESCRIPTION

Hereinafter, example embodiments of the present disclosure will be described in detail with reference to the drawings. The same or corresponding elements and features in the drawings are designated by the same reference numerals, and description thereof will not be duplicated. Each of the drawings shows dimensions of components that may not represent actual dimensions of the components and dimensional ratios of the respective components.

The following description shows that a direction parallel to a central axis P of the laminated core is referred to as an axial direction, a direction orthogonal to the central axis P is referred to as a radial direction, and a direction along an arc centered on the central axis P is referred to as a circumferential direction.

The following description also shows that a direction of a plate thickness of a member in a plate shape is referred to as a thickness direction of the member. The sentence, “when the member is viewed from the thickness direction”, means that the thickness direction coincides with a direction of a line of sight. For example, the sentence, “when a steel plate 80 is viewed from the thickness direction”, means that a surface of the steel plate 80 is viewed from a position away from the steel plate 80 in the thickness direction.

The following description also shows that the expression, “fix”, “connect”, “attach”, or the like, is used not only when members are directly fixed to each other, but also when members are fixed to each other with another member interposed therebetween, for example. That is, the following description shows that the expressions, “fix” and the like, include meaning of direct and indirect fixation of members, for example.

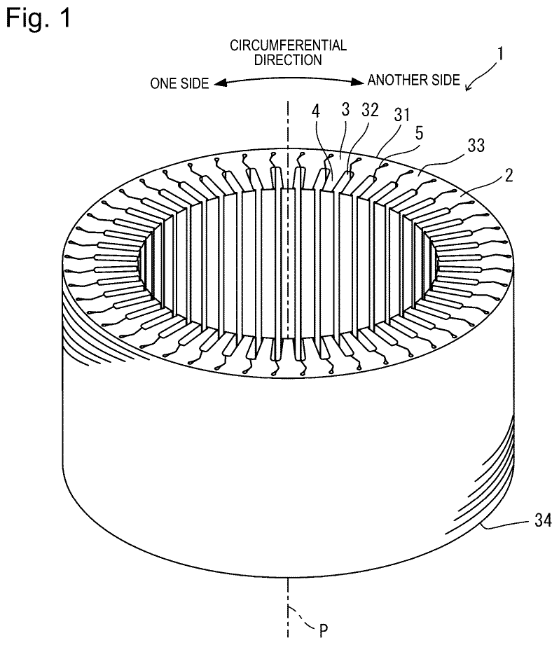

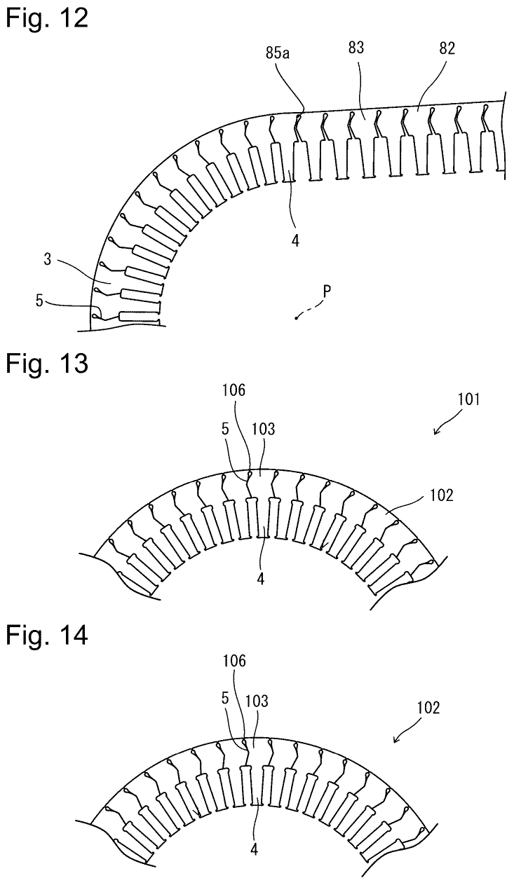

With reference to FIGS. 1 to 12, a laminated core 1 according to a first example embodiment of the present disclosure will be described. As illustrated in FIG. 1, the laminated core 1 has a tubular shape extending along the central axis P. The laminated core 1 in the present example embodiment includes a plurality of core pieces 2 in a plate shape that is stacked in the thickness direction.

As illustrated in FIG. 1, each core piece 2 includes a back yoke portion 3 extending in the circumferential direction of the laminated core 1, and a plurality of tooth portions 4 protruding radially inward of the laminated core 1 from the back yoke portion 3. The core piece 2 is formed by punching a steel plate 80 in a plate shape that is a material of the core piece 2 to form a core piece forming part 82 in a plate shape extending in one direction, and bending the core piece forming part 82 into an annular shape when viewed from the thickness direction. Details of a method for manufacturing the laminated core 1 will be described later.

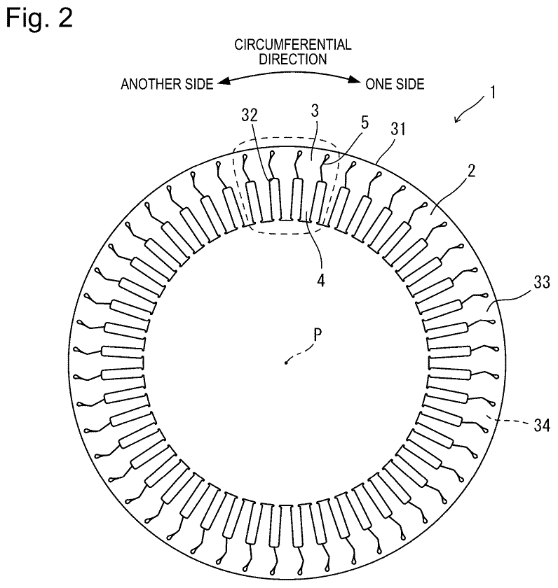

As illustrated in FIG. 2, when the laminated core 1 is viewed from the axial direction, the back yoke portion 3 has an annular shape. The back yoke portion 3 includes an outer peripheral surface 31, an inner peripheral surface 32, a first surface 33 that is one surface in the thickness direction, and a second surface 34 that is the other surface in the thickness direction. The first surface 33 herein is a surface on a side where the next core piece 2 is stacked on the core piece 2 stacked first when the laminated core 1 is manufactured. Each drawing illustrates the central axis P of the laminated core 1 in the vertical direction, and an upper surface serving as the first surface 33. Each drawing does not intend to define a stacking direction of the laminated core 1.

The laminated core 1 includes a plurality of core pieces 2 stacked. That is, the laminated core 1 includes back yoke portions 3 and tooth portions 4 that are stacked in the thickness direction.

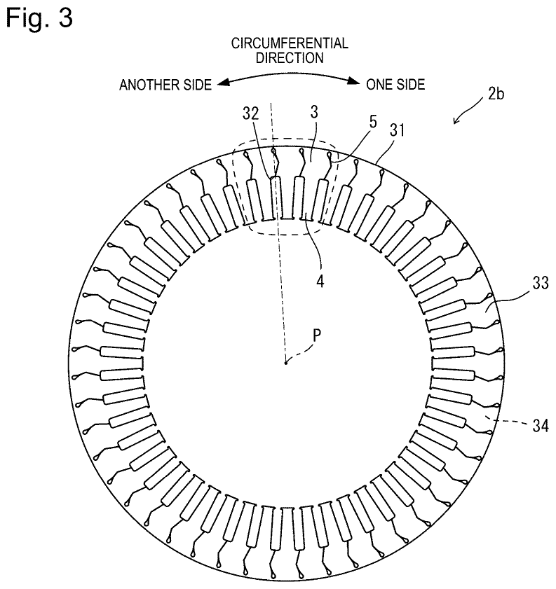

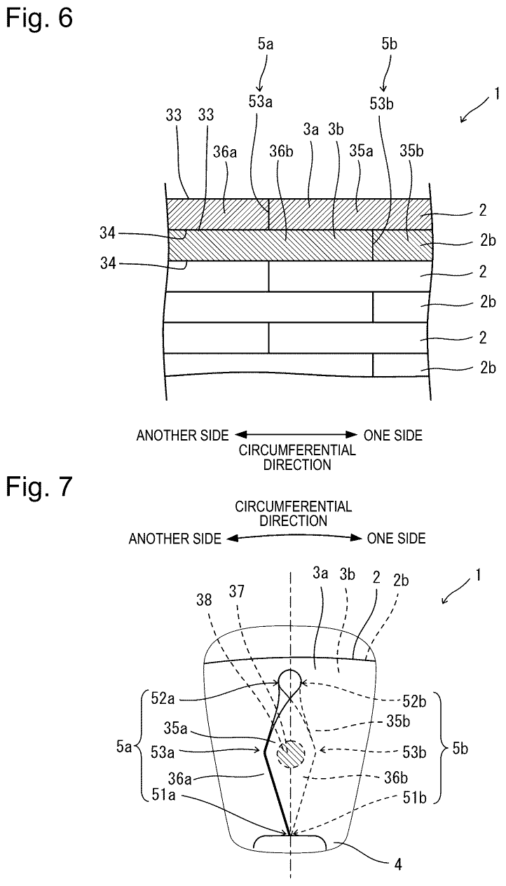

FIG. 3 is a plan view of a core piece 2b stacked below the second surface 34 of the core piece 2 illustrated in FIG. 2. The core piece 2 illustrated in FIG. 2 and the core piece 2b illustrated in FIG. 3 are adjacent to each other in the stacking direction. The core piece 2 illustrated in FIG. 2 is stacked below the second surface 34 of the core piece 2b illustrated in FIG. 3. As described above, the core piece 2 illustrated in FIG. 2 and the core piece 2b illustrated in FIG. 3 are alternately stacked in the present example embodiment as illustrated in FIG. 6.

The back yoke portion 3 includes a cut line 5. As illustrated in FIGS. 2 to 4, the cut line 5 extends in the radial direction of the laminated core 1 from the inner peripheral surface 32 of the back yoke portion 3. The cut line 5 is located between the tooth portions 4 adjacent to each other in the circumferential direction.

The cut line 5 separates a part on one side in the circumferential direction and a part on the other side in the circumferential direction across the cut line 5 in the back yoke portion 3. The back yoke portion 3 in the present example embodiment includes a circumferential one-side separated portion 35 located on the one side in the circumferential direction across the cut line 5 and a circumferential another-side separated portion 36 located on the other side in the circumferential direction across the cut line 5, which are in contact with each other in the circumferential direction.

The core pieces 2 adjacent to each other in the stacking direction are different in shape of the cut line 5 provided in each back yoke portion 3 when viewed from the stacking direction. That is, the cut lines 5 provided in the back yoke portions 3 of the core pieces 2 adjacent to each other in the stacking direction in the laminated core 1 do not at least partially overlap each other when viewed from the stacking direction.

Each back yoke portion 3 is bonded to the back yoke portion 3 adjacent in the stacking direction by an adhesive. The adhesive is capable of bonding metals to each other. The adhesive is an anaerobic adhesive, for example.

As described above, the back yoke portions 3 adjacent to each other in the stacking direction are bonded to each other by the adhesive in the laminated core 1. This configuration enables suppressing movement of one back yoke portion 3 adjacent in the stacking direction with respect to the other back yoke portion 3 in a stacked state.

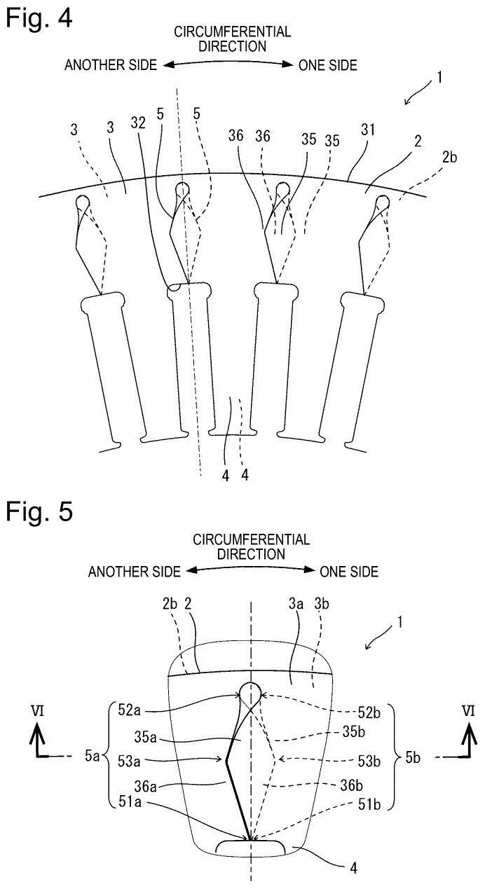

Next, structure of the cut line 5 as an example will be described with reference to FIGS. 4 to 6. Hereinafter, one of the back yoke portions 3 adjacent in the stacking direction is referred to as a first back yoke portion 3a, and the other is referred to as a second back yoke portion 3b, for the sake of description. The back yoke portion 3 includes components that are distinguished by adding a reference numeral “a” to a component of the first back yoke portion 3a and adding a reference numeral “b” to a component of the second back yoke portion 3b.

As illustrated in FIG. 5, the first back yoke portion 3a is provided with a cut line 5a including a radially inner end 51a, a radially outer end 52a, and an intermediate part 53a between the radially inner end 51a and the radially outer end 52a. The second back yoke portion 3b is provided with a cut line 5b including a radially inner end 51b, a radially outer end 52b, and an intermediate part 53b between the radially inner end 51b and the radially outer end 52b.

The radially inner end 51a of the cut line 5a in the first back yoke portion 3a is located at an intermediate point between the tooth portions 4 adjacent to each other in the circumferential direction. The radially outer end 52a is located radially outward of the radially inner end 51a. That is, the radially inner end 51a and the radially outer end 52a are located on a radial line extending in the radial direction of the laminated core 1 and connecting the central axis P of the laminated core 1 and the intermediate point between the tooth portions 4 adjacent to each other in the circumferential direction.

As illustrated in FIG. 5, the radially inner end 51b of the cut line 5b in the second back yoke portion 3b is located at an intermediate point between the tooth portions 4 adjacent to each other in the circumferential direction. Thus, the radially inner end 51b of the cut line 5b in the second back yoke portion 3b overlaps the radially inner end 51a of the cut line 5a in the first back yoke portion 3a when viewed from the stacking direction.

The radially outer end 52b of the cut line 5b in the second back yoke portion 3b is located radially outward of the radially inner end 51b. Thus, the radially outer end 52b of the cut line 5b in the second back yoke portion 3b overlaps the radially outer end 52a of the cut line 5a in the first back yoke portion 3a when viewed from the stacking direction.

That is, the laminated core 1 provided with the cut line 5 as an example includes the radially inner end 51 of the cut line 5 in one of the back yoke portions 3 adjacent to each other in the stacking direction, the radially inner end 51 being located at a position overlapping the radially inner end 51 of the cut line 5 in the other of the back yoke portions 3 adjacent to each other in the stacking direction when viewed from the stacking direction. Then, the radially outer end 52 of the cut line 5 in one of the back yoke portions 3 is located at a position overlapping the radially outer end 52 of the cut line 5 in the other of the back yoke portions 3 when viewed from the stacking direction.

Thus, the laminated core 1 formed by bending the back yoke portion 3 in an arc shape enables one first back yoke portion 3a and the other second back yoke portion 3b of the back yoke portions 3 adjacent to each other in the stacking direction to easily coincide in shape on an inner peripheral side and an outer peripheral side. As a result, the laminated core 1 formed by bending the back yoke portion 3 in an arc shape can be prevented from deteriorating in dimensional accuracy.

As illustrated in FIGS. 5 and 6, the intermediate part 53a of the cut line 5a in the first back yoke portion 3a protrudes toward the other side in the circumferential direction with respect to circumferential positions of the radially inner end 51a and the radially outer end 52a when viewed from the stacking direction. That is, the circumferential one-side separated portion 35a in the first back yoke portion 3a includes a first protrusion protruding toward the other side in the circumferential direction.

The intermediate part 53b of the cut line 5b in the second back yoke portion 3b protrudes toward the one side in the circumferential direction with respect to circumferential positions of the radially inner end 51b and the radially outer end 52b. That is, the circumferential another-side separated portion 36a in the second back yoke portion 3b includes a second protrusion protruding toward the one side in the circumferential direction.

The first protrusion in the first back yoke portion 3a overlaps the second protrusion in the second back yoke portion 3b when the back yoke portion 3 is viewed from the stacking direction.

The circumferential another-side separated portion 36a in the first back yoke portion 3a includes a first recess in which the first protrusion is positioned. The circumferential one-side separated portion 35b in the second back yoke portion 3b includes a second recess in which the second protrusion is positioned.

This configuration enables the circumferential one-side separated portion 35a to be prevented from moving in the radial direction with respect to the circumferential another-side separated portion 36a in the first back yoke portion 3a. This configuration enables also the circumferential one-side separated portion 35b to be prevented from moving in the radial direction with respect to the circumferential another-side separated portion 36b in the second back yoke portion 3b. As a result, the laminated core 1 can be prevented from deteriorating in dimensional accuracy.

As described above, the laminated core 1 includes the first back yoke portion 3a and the second back yoke portion 3b that are adjacent to each other in the stacking direction and that include respective cut lines 5 different in position when viewed from the stacking direction. That is, the laminated core 1 includes the first back yoke portion 3a and the second back yoke portion 3b that are adjacent to each other in the stacking direction, in which one back yoke portion 3 of the first back yoke portion 3a and the second back yoke portion 3b includes parts separated by the cut line 5, and the other back yoke portion 3 thereof extends in the circumferential direction over the parts separated while being stacked on the one back yoke portion 3 in the stacking direction. This configuration causes friction between surfaces of the one back yoke portion 3 and the other back yoke portion 3 in the thickness direction when the circumferential one-side separated portion 35 and the circumferential another-side separated portion 36, serving as the parts on both sides of the cut line 5 in the one back yoke portion 3, try to move in a direction away from each other. Thus, parts on both sides across the cut line 5 of the other back yoke portion 3 can be prevented from separating from each other.

As described above, the laminated core 1 according to an example embodiment of the present disclosure is in a tubular shape, the laminated core 1 including: the back yoke portion 3 in a plate shape extending in the circumferential direction; and the plurality of tooth portions 4 in a plate shape protruding radially inward from the back yoke portion 3, the back yoke portion 3 and the tooth portions 4 being stacked in the thickness direction to extend along the axis of the laminated core 1. The back yoke portion 3 of the laminated core 1 includes the cut line 5 between the tooth portions 4 adjacent to each other in the circumferential direction, the cut line 5 extending in the radial direction from the inner peripheral surface 32. When one of the back yoke portions 3 adjacent to each other in the stacking direction is referred as the first back yoke portion 3a and the other is referred as the second back yoke portion 3b, at least a part of the cut line 5a in the first back yoke portion 3a is located at a position not overlapping the cut line 5b in the second back yoke portion 3b when the back yoke portion 3 is viewed from the stacking direction. The first back yoke portion 3a is at least partially bonded to the second back yoke portion 3b.

The laminated core 1 provided with the back yoke portion 3 extending in the circumferential direction and including the cut line 5 extending in the radial direction may be deteriorated in dimensional accuracy due to separation of a part on the one side and a part on the other side in the circumferential direction across the cut line 5 in the back yoke portion 3. The laminated core 1 described above includes the first back yoke portion 3a and the second back yoke portion 3b that are adjacent to each other in the stacking direction and that include respective cut lines 5 different in position when viewed from the stacking direction. That is, the laminated core 1 includes the first back yoke portion 3a and the second back yoke portion 3b that are adjacent to each other in the stacking direction, in which one back yoke portion 3 of the first back yoke portion 3a and the second back yoke portion 3b includes parts on one side and another side across the cut line 5, and the other back yoke portion 3 extends in the circumferential direction over the parts.

This configuration causes friction between surfaces of the one back yoke portion 3 and the other back yoke portion 3 in the thickness direction when the parts on the one side and the other side across the cut line 5 in the one back yoke portion 3 try to move in a direction away from each other. Thus, parts on both sides across the cut line 5 of the other back yoke portion 3 can be prevented from separating from each other.

The back yoke portions 3 adjacent to each other in the stacking direction are bonded to each other in the above configuration. This configuration enables movement of one back yoke portion 3 with respect to the other back yoke portion 3 to be reliably suppressed. Thus, this configuration enables providing the laminated core 1 in which deterioration in dimensional accuracy is suppressed.

The laminated core 1 is preferably configured such that the circumferential one-side separated portion 35a of the first back yoke portion 3a and the circumferential another-side separated portion 36b of the second back yoke portion 3b are bonded, the circumferential another-side separated portion 36b being stacked below the circumferential one-side separated portion 35a in the stacking direction.

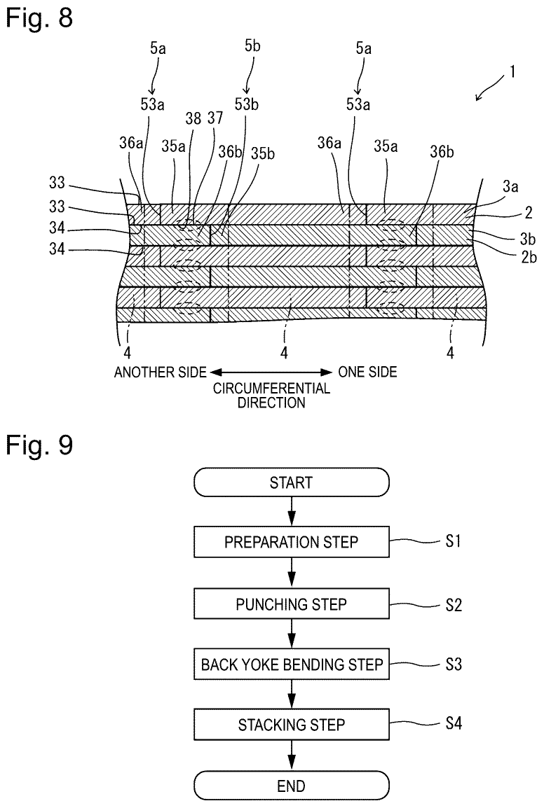

As illustrated in FIGS. 7 and 8, the second back yoke portion 3b includes an adhesive part 37 on the first surface 33 of the circumferential another-side separated portion 36b located on the other side in the circumferential direction. The first back yoke portion 3a includes a bonding part 38 on the second surface 34 of the circumferential one-side separated portion 35a located on the one side in the circumferential direction. The adhesive part 37 is a part to which an adhesive is applied when the laminated core 1 is manufactured. The bonding part 38 is a part that is bonded to the adhesive part 37 by the adhesive applied to the adhesive part 37.

That is, the back yoke portion 3 in the laminated core 1 includes the circumferential one-side separated portion 35 located on the one side in the circumferential direction with respect to the cut line 5, and the circumferential another-side separated portion 36 located on the other side in the circumferential direction with respect to the cut line 5 and in contact with the circumferential one-side separated portion 35 in the circumferential direction. The circumferential one-side separated portion 35a in the first back yoke portion 3a is located at a position overlapping the circumferential another-side separated portion 36b in the second back yoke portion 3b when the back yoke portion 3 is viewed from the stacking direction. The circumferential one-side separated portion 35a in the first back yoke portion 3a is bonded to the circumferential another-side separated portion 36b in the second back yoke portion 3b.

As illustrated in FIG. 8, the circumferential one-side separated portion 35a in the first back yoke portion 3a extends toward the one side in the circumferential direction from the cut line 5a. The circumferential another-side separated portion 36b in the second back yoke portion 3b extends toward the other side in the circumferential direction from the cut line 5b. Thus, bonding the circumferential one-side separated portion 35a in the first back yoke portion 3a to the circumferential another-side separated portion 36b in the second back yoke portion 3b enables connecting a part on the one side in the circumferential direction with respect to the cut line 5a to a part on the other side in the circumferential direction with respect to the cut line 5b in the stacking direction in the laminated core 1 when viewed from the stacking direction. This configuration enables the parts on both the sides of the cut line 5 to be more reliably prevented from being separated from each other in the back yoke portion 3.

The circumferential one-side separated portion 35a in the first back yoke portion 3a in the laminated core 1 includes a first protrusion protruding toward t the other side in the circumferential direction. The circumferential another-side separated portion 36b in the second back yoke portion 3b includes a second protrusion protruding toward the one side in the circumferential direction. The first protrusion in the first back yoke portion 3a is located at a position overlapping the second protrusion in the second back yoke portion 3b when the back yoke portion 3 is viewed from the stacking direction. The first protrusion in the first back yoke portion 3a is bonded to the second protrusion in the second back yoke portion 3b.

The back yoke portions 3 adjacent to each other in the stacking direction can be bonded in the stacking direction using a first protrusion of the circumferential one-side separated portion 35a, the first protrusion protruding toward the other side in the circumferential direction, and a second protrusion of the circumferential another-side separated portion 36b, the second protrusion protruding toward the one side in the circumferential direction. Thus, the back yoke portions 3 adjacent to each other in the stacking direction can be easily and reliably bonded.

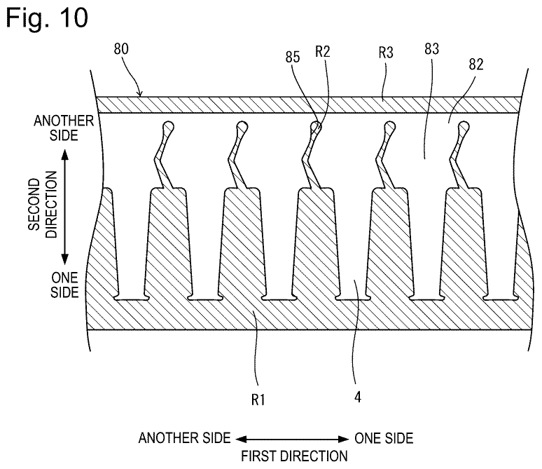

Next, an exemplary method for manufacturing the laminated core 1 having the configuration described above will be described in detail with reference to FIGS. 9 to 12.

FIG. 9 is a flowchart illustrating an example of a method for manufacturing the laminated core 1. As illustrated in FIG. 9, the method for manufacturing the laminated core 1 includes a preparation step S1, a punching step S2, a back yoke bending step S3, and a stacking step S4.

First, the preparation step S1 is performed to prepare an electromagnetic steel plate that is a magnetic material. The electromagnetic steel plate in the present example embodiment has a strip shape elongated in one direction. Hereinafter, the electromagnetic steel plate is referred to as the steel plate 80. The following description shows the one direction that is referred to as a first direction of the steel plate 80, and a direction intersecting the first direction when the steel plate 80 is viewed in the thickness direction, the direction being referred to as a second direction of the steel plate 80.

Next, the punching step S2 is performed to punch out the steel plate 80 to form the core piece forming part 82 in a belt shape. The core piece forming part 82 is to be the core piece 2 in the laminated core 1.

FIG. 10 is a diagram illustrating the core piece forming part 82 punched in the steel plate 80. FIG. 10 illustrates a region of the steel plate 80 to be punched, the region being hatched for the sake of description. The punching step S2 is performed by press working. That is, the punching step S2 is performed to punch out the hatched region in FIG. 10 using a punch. Details of the press working will not be described.

The punching step S2 is performed to punch out a first region R1 of the steel plate 80 to form a back yoke forming portion 83 extending in the first direction and the plurality of tooth portions 4 extending from the back yoke forming portion 83 toward one side in the second direction when the steel plate 80 is viewed from the thickness direction. The core piece forming part 82 in the present example embodiment has a length in the first direction that is substantially equal to a length of an outer circumference of the core piece 2. The tooth portions 4 of the core piece forming part 82 is identical in number to the tooth portions 4 of the core piece 2.

Additionally, the punching step S2 is performed to punch out a second region R2 extending in the second direction between the tooth portions 4 adjacent to each other in the first direction in the back yoke forming portion 83 to form a slit 85 having a predetermined width extending toward the other side in the second direction. The slit 85 is to be the cut line 5 of the laminated core 1.

The slit 85 in the present example embodiment is formed at different positions in one back yoke portion 3 and the other back yoke portion 3 adjacent to each other in the stacking direction in the laminated core 1. For example, the punching step S2 in the present example embodiment is performed to form a first core piece forming part 82a, in which a first slit 85a to be the cut line 5a of the laminated core 1 is formed, in the back yoke forming portion 83a. Additionally, a second core piece forming part 82b, in which a second slit 85b to be the cut line 5b of the laminated core 1 is formed, is formed in the back yoke forming portion 83b.

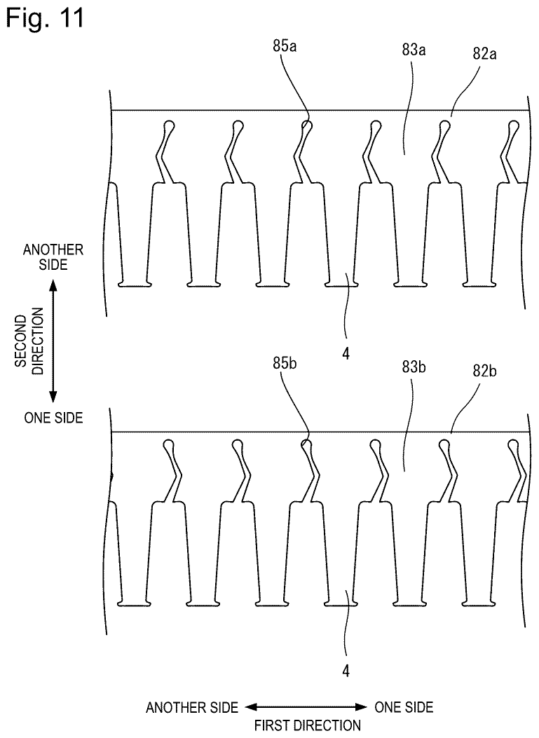

Then, the punching step S2 is performed to punch out a third region R3 of the steel plate 80 to form a part to be the outer peripheral surface 31 of the back yoke portion 3 in the laminated core 1. FIG. 11 illustrates the first core piece forming part 82a and the second core piece forming part 82b formed in the punching step S2.

The punching step S2 may be performed to punch out the first region R1, the second region R2, and the third region R3 in any order. That is, the punching step S2 may be performed to punch out the second region R2 before the first region R1 is punched out, or after the first region R1 is punched out. The third region R3 may be punched out before the first region R1 is punched out, or may be punched out after the first region R1 is punched out. The third region R3 may be punched out before the second region R2 is punched out, or may be punched out after the second region R2 is punched out. The first region R1, the second region R2, and the third region R3 may be simultaneously punched out. Two regions of the first region R1, the second region R2, and the third region R3 may be simultaneously punched out.

Next, the back yoke bending step S3 is performed to bend the back yoke forming portion 83 of the core piece forming part 82 formed in the punching step S2 in an arc shape when viewed in the thickness direction. Specifically, the back yoke forming portion 83 is bent in an arc shape while a gap of the slit 85 formed by punching out the second region R2 is closed. As a result, the back yoke forming portion 83 includes both ends extending in the longitudinal direction in which the end on a side where the plurality of tooth portions 4 is located has a length that can be reduced to less than a length of the end located on the outer peripheral side in the laminated core 1. Thus, the back yoke portion 3 in an annular shape is formed when viewed from the thickness direction.

After that, the stacking step S4 is performed to stack and bond the back yoke portion 3 bent in an arc shape in the back yoke bending step S3 in the stacking direction.

Through the above steps, the laminated core 1 is manufactured in which the back yoke portion 3 in a plate shape and the plurality of tooth portions 4 in a plate shape are stacked in the thickness direction.

That is, the exemplary method for manufacturing the laminated core 1 according to the present example embodiment includes the punching step S2, the back yoke bending step S3, and the stacking step S4.

The punching step S2 is performed to punch out the steel plate 80 to form the back yoke forming portion 83 extending in the first direction, the plurality of tooth portions 4 extending from the back yoke forming portion 83 toward one side in the second direction intersecting the first direction when the steel plate 80 is viewed from the thickness direction, and the slit 85 extending toward the other side in the second direction between the tooth portions 4 adjacent to each other in the first direction in the back yoke forming portion 83. The back yoke bending step S3 is performed to bend the back yoke forming portion 83 formed in the punching step S2 in an arc shape when viewed from the thickness direction by closing the gap of the slit 85, thereby forming the back yoke portion 3. The stacking step S4 is performed to bond the back yoke portion 3 bent in an arc shape in the back yoke bending step S3 while the back yoke portion 3 is stacked in the stacking direction. The punching step S2 is performed to form the slit 85 at a first position in one of the back yoke portions 3 adjacent to each other in the stacking direction and form the slit 85 at a second position in the other of the back yoke portions 3, the first position being different from the second position.

The method for manufacturing the laminated core 1 described above is performed in which one back yoke forming portion 83 and the other back yoke forming portion 83, which are to be the back yoke portions 3 adjacent to each other in the stacking direction, are different from each other in position of the slit 85. As a result, the laminated core 1 manufactured by the method for manufacturing the laminated core 1 described above includes the back yoke portions 3 adjacent to each other in the stacking direction in which one of the back yoke portions 3 is different in position of the cut line 5 from the other of the back yoke portions 3, the cut line 5 being formed by filling the gap of the slit 85, when viewed from the stacking direction. That is, the laminated core 1 includes the back yoke portions 3 adjacent to each other in the stacking direction, in which one of the back yoke portions 3 includes parts on one side and another side across the cut line 5, and the other back yoke portion 3 extends in the circumferential direction over the parts. This configuration causes friction between surfaces of the one back yoke portion 3 and the other back yoke portion 3 in the thickness direction when the parts on the one side and the other side across the cut line 5 in the one back yoke portion 3 try to move in a direction away from each other. Thus, parts on both sides across the cut line 5 of the other back yoke portion 3 can be prevented from separating from each other.

The above manufacturing method allows the back yoke portions 3 adjacent to each other in the stacking direction to be bonded to each other. As a result, movement of one of the back yoke portions 3 with respect to the other of the back yoke portions 3 is suppressed in the laminated core 1. Thus, a method of manufacturing the laminated core 1 can be provided in which deterioration in dimensional accuracy of the laminated core 1 is suppressed.

The slit 85 in the present example embodiment includes the first slit 85a including a first protrusion protruding toward the other side in the first direction and the second slit 85b including a second protrusion protruding toward the one side in the first direction.

That is, the punching step S2 is performed to form not only the first slit 85a in one of the back yoke portions 3 adjacent to each other in the stacking direction in the laminated core 1, but also the second slit 85b in the other of the back yoke portions 3 adjacent to each other in the stacking direction. The punching step S2 of the present example embodiment is performed to bond the first protrusion of the first slit 85a of one of the back yoke portions 3 adjacent to each other in the stacking direction to the second protrusion of the second slit 85b of the other of the back yoke portions 3 adjacent to each other in the stacking direction while the back yoke portions 3 bent in an arc shape in the back yoke bending step S3 are stacked in the stacking direction.

The back yoke portions 3 adjacent to each other in the stacking direction can be bonded in the stacking direction using the first protrusion of the circumferential one-side separated portion 35a, the first protrusion protruding toward the other side in the circumferential direction, for one of the tooth portions 4 adjacent to each other in the circumferential direction, and the second protrusion of the circumferential another-side separated portion 36b, the second protrusion protruding to the one side in the circumferential direction, for the other of the tooth portions 4 adjacent to each other in the circumferential direction. Thus, the back yoke portions 3 adjacent to each other in the stacking direction can be easily and reliably bonded.

Next, a laminated core 101 according to a second example embodiment of the present disclosure will be described with reference to FIGS. 13 to 15. The present example embodiment shows a back yoke portion 103 that is different in configuration from the back yoke portion 3 of the first example embodiment. Hereinafter, the same components as those of the first example embodiment are denoted by the same reference signs, and will not be described.

The laminated core 101 includes the plurality of core pieces 102 stacked. Each core piece 102 includes the back yoke portion 103 and the tooth portion 4.

The back yoke portion 103 in the present example embodiment includes the cut line 5 and an outer-peripheral-side recess 106.

FIG. 13 is a partially enlarged view of the laminated core 101 when viewed from the stacking direction. FIG. 14 is a view of the core piece 102 stacked in the stacking direction with respect to the core piece 102 illustrated in FIG. 13 when viewed from the stacking direction. The core piece 102 illustrated in FIG. 13 and the core piece 102 illustrated in FIG. 14 are adjacent to each other in the stacking direction. That is, the cut lines 5 provided in the back yoke portions 103 of the core pieces 102 adjacent to each other in the stacking direction in the laminated core 101 do not at least partially overlap each other when viewed from the stacking direction.

A configuration of each of the cut lines 5 of the back yoke portions 103 and a positional relationship between the cut lines 5 of the back yoke portions 103 adjacent to each other in the stacking direction are similar to those in the first example embodiment, and thus will not be described.

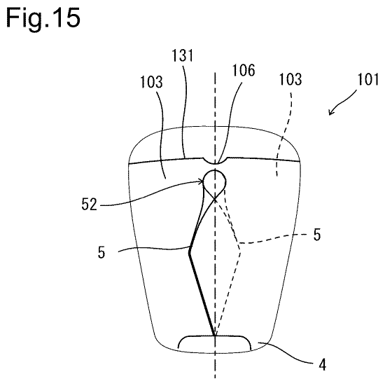

As illustrated in FIG. 15, the outer-peripheral-side recess 106 is located radially outward of the cut line 5 in an outer peripheral surface 131 of the back yoke portion 103. The outer-peripheral-side recess 106 is recessed in the radial direction. That is, the back yoke portion 103 includes the outer-peripheral-side recess 106 recessed toward the inner peripheral side at a position radially outward of the radially outer end 52 of the cut line 5 in the outer peripheral surface 131 of the back yoke portion 103.

The outer-peripheral-side recess 106 allows a distance between the radially outer end 52 of the cut line 5 and the outer peripheral surface 131 of the back yoke portion 103 to be shortened. As a result, the back yoke portion 103 can be easily bent between the radially outer end 52 of the cut line 5 and the outer-peripheral-side recess 106. Thus, positions where the respective back yoke portions 103 are bent in an arc shape can be easily aligned in the plurality of core pieces 102 of the laminated core 101. As a result, the laminated core 101 formed by bending the back yoke portion in an arc shape can be prevented from deteriorating in dimensional accuracy.

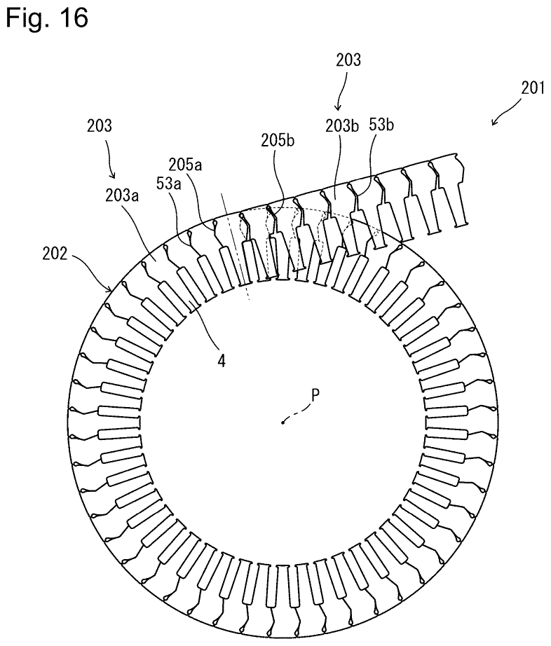

Next, a laminated core 201 according to a third example embodiment of the present disclosure will be described with reference to FIGS. 16 to 18. The laminated core 201 in the present example embodiment is formed by a spiral method in which a core piece 202 in a belt shape punched into a predetermined shape is spirally wound while being bent in an arc shape when viewed in the thickness direction. That is, the laminated core 201 according to the present example embodiment is composed of one core piece 202 extending spirally along an axis.

FIG. 16 is a diagram illustrating the laminated core 201 that is partly disassembled. The core piece 202 includes a back yoke portion 203 and a plurality of tooth portions 4. The back yoke portion 203 includes cut lines 205a and 205b.

One back yoke portion 203 and the other back yoke portion 203 of back yoke portions 203 adjacent to each other in the stacking direction in the laminated core 201 in the present example embodiment are composed of respective parts of one back yoke portion extending in a spiral shape.

Cut lines 205 each in the present example embodiment has structure as with the cut line 5 of the first example embodiment. That is, when one of the back yoke portions 203 adjacent to each other in the stacking direction is referred as a first back yoke portion 203a and the other is referred as a second back yoke portion 203b, at least a part of the cut line 205a in the first back yoke portion 203a is located at a position not overlapping the cut line 205b in the second back yoke portion 203b when the back yoke portion 203 is viewed from the stacking direction. Specifically, an intermediate part 53a of the cut line 205a protrudes toward the other side in the circumferential direction. Then, an intermediate part 53b of the cut line 205b protrudes toward the one side in the circumferential direction. FIG. 16 shows a two-dot chain line that indicates a boundary between the first back yoke portion 203a and the second back yoke portion 203b.

As described above, the laminated core 201 according to the present example embodiment includes the back yoke portion 203 extending spirally about the axis and being stacked in the stacking direction.

The laminated core, in which the back yoke portion formed in a straight line is bent in an arc shape and the back yoke portion extending spirally about the axis is stacked in the stacking direction as described above, may cause spring back in the back yoke portion, and thus the laminated core may be deteriorated in dimensional accuracy. In contrast, the laminated core 201 according to the present example embodiment suppresses relative movement of the back yoke portions 203 adjacent to each other in the stacking direction. Thus, the laminated core 201 including the back yoke portion 203 spirally extending enables suppressing occurrence of spring back in the back yoke portion 203. As a result, the laminated core 201 can be prevented from deteriorating in dimensional accuracy.

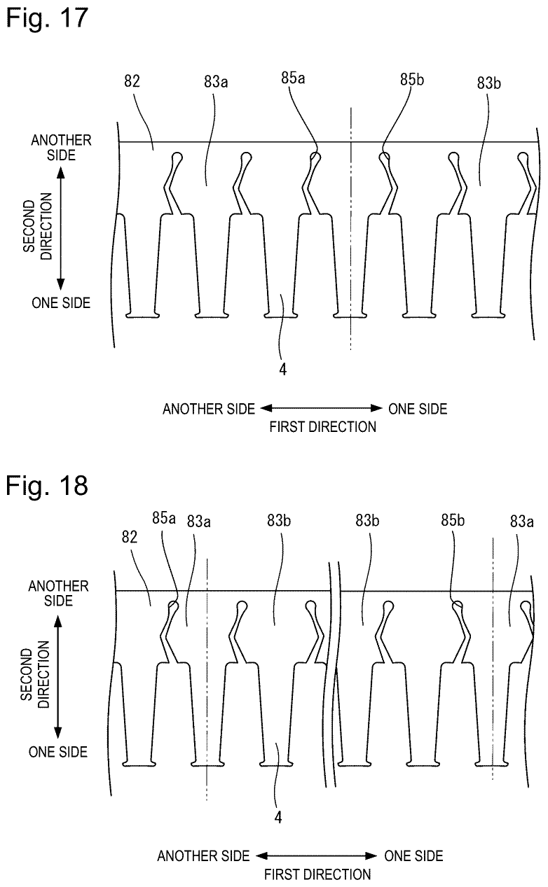

Next, a method for manufacturing the laminated core 201 will be described. The method for manufacturing the laminated core 201 includes a preparation step S1, a punching step S202, a back yoke bending step S3, and a stacking step S4. FIGS. 17 and 18 are each an exemplary diagram of punching for manufacturing the laminated core 201. FIGS. 17 and 18 each show a two-dot chain line that indicates a boundary between a part to be the first back yoke portion 203a and a part to be the second back yoke portion 203b.

As in the first example embodiment, the punching step S202 is performed to punch out a third region R3 from a first region R1 of the steel plate steel plate 80 to form a back yoke forming portion 83 extending in the first direction and the plurality of tooth portions 4 extending from the back yoke forming portion 83 toward one side in the second direction when the steel plate 80 is viewed from the thickness direction.

The core piece forming part 82 in the present example embodiment has a length in the first direction that is longer than a length of an outer circumference of the laminated core 201. That is, the back yoke forming portion 83 formed in the present example embodiment is spirally wound. Thus, parts each serving as the back yoke forming portion 83 are stacked in the stacking direction.

The slits 85 of the back yoke forming portion 83 are formed at different positions at the respective parts stacked in the stacking direction in the laminated core 201. That is, the punching step S202 in the present example embodiment is performed to form each of the slits 85 and the slit 85 separated from corresponding one of the slits 85 in the first direction by the number of the cut lines 205 of the laminated core 201 at different positions when viewed in the stacking direction.

For example, when the number of the cut lines 205 of the laminated core 201 viewed from the stacking direction is 24, the slits 85 aligned in the first direction as illustrated in FIG. 17 may be changed in shape every 24 cut lines 205 in the punching step S202. As illustrated in FIG. 18, the slits 85 aligned in the first direction may be changed in shape at a position separated by 24 cut lines in the punching step S202.

Next, a laminated core 301 according to a fourth exemplary example embodiment of the present disclosure will be described with reference to FIGS. 11, 19, and 20. The laminated core 301 in the present example embodiment is formed by a spiral method in which two core pieces 302, which are each in a belt shape punched into a predetermined shape, are each spirally wound while being bent in an arc shape when viewed in the thickness direction. That is, the laminated core 301 according to the present example embodiment is composed of two core pieces 302a and 302b extending spirally along an axis.

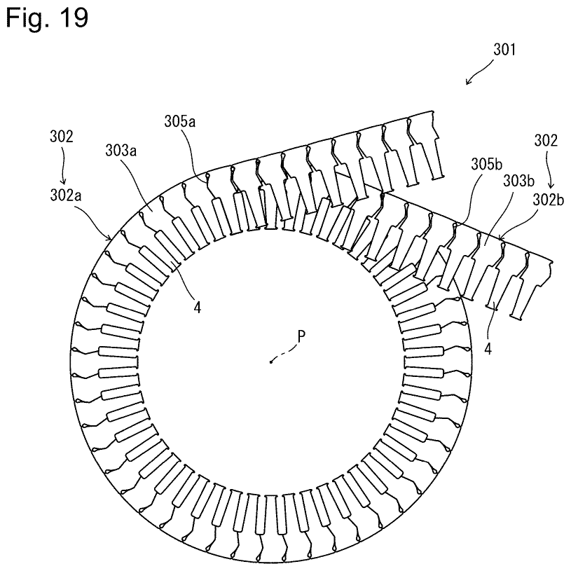

FIG. 19 is a diagram illustrating the laminated core 301 that is partly disassembled. Each of the two core pieces 302a and 302b is spirally wound. The core piece 302a of one of two core pieces 302 is stacked adjacent in the stacking direction to the core piece 302b of the other of the two core pieces 302.

The core piece 302a includes a first back yoke portion 303a and a plurality of tooth portions 4. The first back yoke portion 303a includes a cut line 305a. The core piece 302b includes a second back yoke portion 303b and a plurality of tooth portions 4. The second back yoke portion 303b includes a cut line 305b.

One of back yoke portions 303 adjacent in the stacking direction in the laminated core 301 in the present example embodiment is composed of the first back yoke portion 303a of the core piece 302a. The other of the back yoke portions 303 is composed of the second back yoke portion 303b of the core piece 302b.

Cut lines 305 each in the present example embodiment has structure as with the cut line 5 of the first example embodiment. At least a part of the cut line 305a in the first back yoke portion 303a is located at a position not overlapping the cut line 305b in the second back yoke portion 303b when the back yoke portion 303 is viewed from the stacking direction.

As described above, the back yoke portion 303 of the present example embodiment includes the first back yoke portion 303a extending spirally about the axis and stacked in the stacking direction, and the second back yoke portion 303b extending spirally about the axis and stacked adjacent in the stacking direction to the first back yoke portion 303a stacked in the stacking direction.

The first back yoke portion 303a includes a circumferential one-side separated portion 35a located on the one side in the circumferential direction with respect to the cut line 305a, and a circumferential another-side separated portion 36a located on the other side in the circumferential direction with respect to the cut line 305a and in contact with the circumferential one-side separated portion 35a in the circumferential direction. The second back yoke portion 303b includes a circumferential one-side separated portion 35b located on the one side in the circumferential direction with respect to the cut line 305b, and a circumferential another-side separated portion 36b located on the other side in the circumferential direction with respect to the cut line 305b and in contact with the circumferential one-side separated portion 35b in the circumferential direction.

The circumferential one-side separated portion 35a in the first back yoke portion 303a includes a first protrusion protruding toward the other side in the circumferential direction. The circumferential another-side separated portion 36a in the first back yoke portion 303a includes a first recess in which the first protrusion is positioned. The circumferential another-side separated portion 36b in the second back yoke portion 303b includes a second protrusion protruding toward the one side in the circumferential direction. The circumferential one-side separated portion 35b in the second back yoke portion 303b includes a second recess in which the second protrusion is positioned.

The first protrusion in the first back yoke portion 303a is located at a position overlapping the second protrusion in the second back yoke portion 303b when the back yoke portion 303 is viewed from the stacking direction. The first protrusion in the first back yoke portion 303a is bonded to the second protrusion in the second back yoke portion 303b.

To change cut lines in position, the cut lines being adjacent to each other in the stacking direction in the laminated core composed of one spiral back yoke portion, the protrusion is required to be changed in protruding direction for each layer. In contrast, the above configuration includes the first back yoke portion 303a including the first protrusion protruding toward the other side in the circumferential direction, and the second back yoke portion 303b including the second protrusion protruding to the one side in the circumferential direction, which are alternately stacked in the stacking direction. This configuration enables the cut line 305 to be easily changed in position between one and the other of the back yoke portions 303 adjacent in the stacking direction when viewed from the stacking direction. As a result, the laminated core 301 bent in an arc shape can be easily prevented from deteriorating in dimensional accuracy.

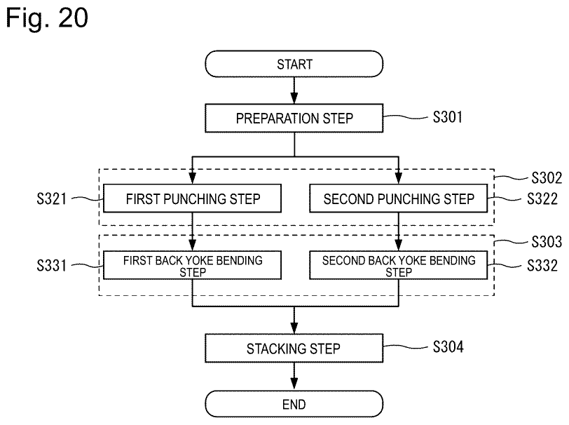

Next, an exemplary method for manufacturing the laminated core 301 will be described with reference to FIGS. 11 and 20. As illustrated in FIG. 20, the method for manufacturing the laminated core 301 includes a preparation step S301, a punching step S302, a back yoke bending step S303, and a stacking step S304. The punching step S302 in the present example embodiment includes a first punching step S321 and a second punching step S322. The back yoke bending step S303 includes a first back yoke bending step S331 and a second back yoke bending step S332.

The preparation step S301 is similar to the preparation step S1 of the first example embodiment. Thus, the preparation step S301 will not be described.

The punching step S302 is performed to punch the steel plate 80 to form a first core piece forming part 82a in a belt shape and a second core piece forming part 82b in a belt shape. The first core piece forming part 82a and the second core piece forming part 82b formed in the punching step S302 are respectively similar to the first core piece forming part 82a and the second core piece forming part 82b of the first example embodiment illustrated in FIG. 11.

The first core piece forming part 82a is to be the core piece 302a in the laminated core 301. The second core piece forming part 82b is to be the core piece 302b in the laminated core 301.

Specifically, the first punching step S321 is performed to punch the steel plate 80 to form the first back yoke forming portion 83a, a first plurality of tooth portions 4, and a first slit 85a. That is, the first punching step S321 is performed to form the first core piece forming part 82a in which the first slit 85a provided with an intermediate part protrudes toward the other side in the first direction is formed. The first slit 85a is to be the cut line 305a of the laminated core 301.

The second punching step S322 is performed to punch the steel plate 80 to form the second back yoke forming portion 83b, a second plurality of tooth portions 4, and a second slit 85b. That is, the second punching step S322 is performed to form the second core piece forming part 82b in which the second slit 85b provided with an intermediate part protruding toward the one side in the first direction is formed. The second slit 85b is to be the cut line 305b of the laminated core 301.

The first back yoke bending step S331 is performed to bend the first back yoke forming portion 83a in an arc shape by closing a gap of the first slit 85a when the first back yoke forming portion 83a is viewed from the thickness direction. Thus, the first back yoke portion 303a is formed. The second back yoke bending step S332 is performed to bend the second back yoke forming portion 83b in an arc shape by closing a gap of the second slit 85b when the second back yoke forming portion 83b is viewed from the thickness direction. Thus, the second back yoke portion 303b is formed.

The stacking step S304 is performed to alternately stack and bond the first back yoke portion 303a bent in an arc shape in the first back yoke bending step S331 and the second back yoke portion 303b bent in an arc shape in the second back yoke bending step S332 in the stacking direction. That is, the first protrusion in the first back yoke portion 303a is bonded to the second protrusion in the second back yoke portion 303b.

The second punching step S322 may be performed after the first punching step S321 or before the first punching step S321. The second back yoke bending step S332 may be performed after the first back yoke bending step S331 or before the first back yoke bending step S331.

That is, the method for manufacturing the laminated core 301 according to the present example embodiment includes the punching step S302 including: the first punching step S321 of punching the steel plate 80 to form the first back yoke forming portion 83a, the first plurality of tooth portions 4, and the first slit 85a; and the second punching step S322 of punching the steel plate 80 to form the second back yoke forming portion 83b, the second plurality of tooth portions 4, and the second slit 85b. The back yoke bending step S303 includes: the first back yoke bending step S331 of forming the first back yoke portion 303a by closing a gap of the first slit 85a and bending the first back yoke forming portion 83a in an arc shape when the first back yoke forming portion 83a formed in the first punching step S321 is viewed from the thickness direction; and the second back yoke bending step S332 of forming the second back yoke portion 303b by closing a gap of the second slit 85b and bending the second back yoke forming portion 83b in an arc shape when the second back yoke forming portion 83b formed in the second punching step S322 is viewed from the thickness direction. The stacking step S304 is performed to alternately stack and bond the first back yoke portion 303a bent in an arc shape in the first back yoke bending step S331 and the second back yoke portion 303b bent in an arc shape in the second back yoke bending step S332 in the stacking direction.

To change cut lines 205 in position, the cut lines 205 being adjacent to each other in the stacking direction in the laminated core 201 composed of one spiral back yoke portion 203, the protrusion is required to be changed in protruding direction for each layer. In contrast, the above manufacturing method is performed to alternately stack the first back yoke portion 303a and the second back yoke portion 303b in the stacking direction, the first back yoke portion 303a including the first protrusion protruding toward the other side in the circumferential direction, and the second back yoke portion 303b including the second protrusion protruding to the one side in the circumferential direction. This configuration enables the cut line 305 to be easily changed in position between one and the other of the back yoke portions 303 adjacent in the stacking direction when viewed from the stacking direction. As a result, a manufacturing method can be provided in which the laminated core 301 bent in an arc shape can be easily prevented from deteriorating in dimensional accuracy.

Although the example embodiments of the present disclosure are described above, the above-described example embodiments are merely examples for implementing the present disclosure. Thus, the present disclosure is not limited to the example embodiments described above, and the example embodiments described above may be appropriately modified and implemented without departing from the scope of the present disclosure.

The core piece 2 in each of the above example embodiments includes the back yoke portion 3 extending in the circumferential direction of the laminated core 1, and the plurality of tooth portions 4 extending from the back yoke portion 3 toward the central axis P of the laminated core 1. Alternatively, the core piece may include a back yoke portion extending in the circumferential direction of the laminated core, and a plurality of tooth portions extending from the back yoke portion toward the radial outside of the laminated core.

The back yoke portion 3 in each of the above example embodiments includes a circumferential one-side separated portion 35 located on the one side in the circumferential direction across the cut line 5, 205, or 305, and a circumferential another-side separated portion 36 located on the other side in the circumferential direction across the cut line 5, 205, or 305, which are in contact with each other in the circumferential direction. Alternatively, the circumferential one-side separated portion and the circumferential another-side separated portion may face each other with a predetermined gap.

The present technique can also have configurations as described below.

(1) A laminated core is in a tubular shape, and includes a back yoke portion in a plate shape extending in a circumferential direction, and tooth portions in a plate shape protruding radially inward from the back yoke portion, the back yoke portion and the tooth portions being stacked in a thickness direction of the laminated core to extend along an axis of the laminated core. The back yoke portion includes a cut line between ones of the tooth portions adjacent to each other in the circumferential direction, the cut line extending in a radial direction from an inner peripheral surface. When one of back yoke portions adjacent to each other in a stacking direction is referred as a first back yoke portion and another one of the two back yoke portions adjacent to each other in the stacking direction is referred as a second back yoke portion, at least a portion of the cut line in the first back yoke portion is located at a position not overlapping the cut line in the second back yoke portion when the back yoke portion is viewed from the stacking direction. The first back yoke portion is at least partially bonded to the second back yoke portion.

(2) The laminated core described in the litem (1) is configured such that the back yoke portion includes a circumferential one-side separated portion located on one side in the circumferential direction with respect to the cut line, and a circumferential another-side separated portion located on the other side in the circumferential direction with respect to the cut line and in contact with the circumferential one-side separated portion in the circumferential direction. The circumferential one-side separated portion in the first back yoke portion is located at a position overlapping the circumferential another-side separated portion in the second back yoke portion when the back yoke portion is viewed from the stacking direction. The circumferential one-side separated portion in the first back yoke portion is bonded to the circumferential another-side separated portion in the second back yoke portion.

(3) The laminated core described in the item (2) is configured such that the circumferential one-side separated portion in the first back yoke portion includes a first protrusion protruding toward the other side in the circumferential direction. The circumferential another-side separated portion in the second back yoke portion includes a second protrusion protruding toward the one side in the circumferential direction. The first protrusion in the first back yoke portion is located at a position overlapping the second protrusion in the second back yoke portion when the back yoke portion is viewed from the stacking direction. The first protrusion in the first back yoke portion is bonded to the second protrusion in the second back yoke portion.

(4) The laminated core described in the item (3) is configured such that the circumferential another-side separated portion in the first back yoke portion includes a first recess in which the first protrusion is positioned. The circumferential one-side separated portion in the second back yoke portion includes a second recess in which the second protrusion is positioned.

(5) The laminated core described in any one of the items (1) to (4) is configured such that the back yoke portion extends spirally about an axis of the laminated core and is stacked in the stacking direction.

(6) The laminated core described in the item (5) is configured such that the back yoke portion includes the first back yoke portion extending spirally about the axis and stacked in the stacking direction, and the second back yoke portion extending spirally about the axis and stacked adjacent in the stacking direction to the first back yoke portion stacked in the stacking direction. The first back yoke portion includes a circumferential one-side separated located portion on one side in the circumferential direction with respect to the cut line, and a circumferential another-side separated portion located on the other side in the circumferential direction with respect to the cut line and in contact with the circumferential one-side separated portion in the circumferential direction. The second back yoke portion includes a circumferential one-side separated portion located on one side in the circumferential direction with respect to the cut line, and a circumferential another-side separated portion located on the other side in the circumferential direction with respect to the cut line and in contact with the circumferential one-side separated portion in the circumferential direction. The circumferential one-side separated portion in the first back yoke portion includes a first protrusion protruding toward the other side in the circumferential direction, and the circumferential another-side separated portion in the first back yoke portion includes a first recess in which the first protrusion is positioned. The circumferential another-side separated portion in the second back yoke portion includes a second protrusion protruding toward the one side in the circumferential direction, and the circumferential one-side separated portion in the second back yoke portion includes a second recess in which the second protrusion is positioned. The first protrusion in the first back yoke portion is located at a position overlapping the second protrusion in the second back yoke portion when the back yoke portion is viewed stacking direction. The first protrusion in the first back yoke portion is bonded to the second protrusion in the second back yoke portion.

(7) The laminated core described in the item (5) or (6) is configured such that one of the back yoke portions adjacent to each other in the stacking direction includes the cut line with a radially inner end located at a position overlapping a radially inner end of the cut line in the other of the back yoke portions adjacent to each other in the stacking direction when viewed from the stacking direction. The cut line in the one of the back yoke portions includes a radially outer end located at a position overlapping a radially outer end of the cut line in the other of the back yoke portions when viewed from the stacking direction.

(8) The laminated core described in the item (7) is configured such that the back yoke portion includes an outer-peripheral-side recess recessed toward the inner peripheral side at a position radially outward of the radially outer end of the cut line in an outer peripheral surface of the back yoke portion.

(9) A method for manufacturing a laminated core is configured to manufacture a laminated core in which a back yoke portion in a plate shape and tooth portions in a plate shape are stacked in a thickness direction of the laminated core. The method for manufacturing the laminated core includes: a punching step of punching a steel plate to form a back yoke forming portion extending in a first direction, the plurality of tooth portions extending from the back yoke forming portion toward one side in a second direction intersecting the first direction when the steel plate is viewed in its thickness direction, and a slit extending toward the other side in the second direction between the tooth portions adjacent to each other in the first direction in the back yoke forming portion; a back yoke bending step of forming the back yoke portion by bending the back yoke forming portion in an arc shape by closing a gap of the slit when the back yoke forming portion formed in the punching step is viewed in the thickness direction; and a stacking step of bonding the back yoke portion bent in an arc shape in the back yoke bending step while the back yoke portions are stacked in a stacking direction. The punching step is performed to form the slit at a first position in one of two of the back yoke portions adjacent to each other in the stacking direction and form the slit at a second position in another one of the back yoke portions different to each other in the stacking direction, the first position being different from the second position.

(10) The method for manufacturing a laminated core described in the item (9) is configured such that the slit includes a first slit including a first protrusion protruding toward another side in the first direction and a second slit including a second protrusion protruding toward one side in the first direction. The punching step is performed to form not only the first slit in one of the back yoke portions adjacent to each other in the stacking direction, but also the second slit in the other of the back yoke portions adjacent to each other in the stacking direction. The first protrusion of the first slit of one of the back yoke portions adjacent to each other in the stacking direction is bonded to the second protrusion of the second slit of the other of the back yoke portions adjacent to each other in the stacking direction while the back yoke portions bent in an arc shape in the back yoke bending step are stacked in the stacking direction.

(11) The method for manufacturing a laminated core described in the item (10) is configured such that the punching step includes a first punching step of punching a steel plate to form a first back yoke forming portion, a first plurality of the tooth portions, and the first slit, and a second punching step of punching the steel plate to form a second back yoke forming portion, second tooth portions, and the second slit. The back yoke bending step includes a first back yoke bending step of forming a first back yoke portion by closing a gap of the first slit and bending the first back yoke forming portion in an arc shape when the first back yoke forming portion formed in the first punching step is viewed from the thickness direction, and a second back yoke bending step of forming a second back yoke portion by closing a gap of the second slit and bending the second back yoke forming portion in an arc shape when the second back yoke forming portion formed in the second punching step is viewed from the thickness direction. The stacking step is performed to alternately stack and bond the first back yoke portion bent in an arc shape in the first back yoke bending step and the second back yoke portion bent in an arc shape in the second back yoke bending step in the stacking direction.

The present disclosure is applicable to a method for manufacturing a laminated core in which an electromagnetic steel plate in a belt shape is punched to form a back yoke portion extending linearly in a longitudinal direction of the electromagnetic steel plate and a plurality of teeth extending in a width direction of the electromagnetic steel plate.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A laminated core in a tubular shape, the laminated core comprising:
a back yoke portion in a plate shape extending in a circumferential direction; and
tooth portions in a plate shape protruding radially inward from the back yoke portion; wherein
the back yoke portion and the tooth portions are stacked in a thickness direction of the laminated core to extend along an axis of the laminated core;
the back yoke portion includes a cut line between ones of the tooth portions adjacent to each other in the circumferential direction, the cut line extending in a radial direction from an inner peripheral surface;
when one of the back yoke portions adjacent to each other in a stacking direction is referred to as a first back yoke portion and another one of the two back yoke portions adjacent to each other in the stacking direction is referred to as a second back yoke portion, at least a portion of the cut line in the first back yoke portion is located at a position not overlapping the cut line in the second back yoke portion when the back yoke portion is viewed from the stacking direction; and
the first back yoke portion is at least partially bonded to the second back yoke portion.

2. The laminated core according to claim 1, wherein
the back yoke portion includes a circumferential one-side separated portion located on one side in the circumferential direction with respect to the cut line, and a circumferential another-side separated portion located on another side in the circumferential direction with respect to the cut line and in contact with the circumferential one-side separated portion in the circumferential direction;
the circumferential one-side separated portion in the first back yoke portion is located at a position overlapping the circumferential another-side separated portion in the second back yoke portion when the back yoke portion is viewed from the stacking direction; and
the circumferential one-side separated portion in the first back yoke portion is bonded to the circumferential another-side separated portion in the second back yoke portion.

3. The laminated core according to claim 2, wherein
the circumferential one-side separated portion in the first back yoke portion includes a first protrusion protruding toward the other side in the circumferential direction;
the circumferential another-side separated portion in the second back yoke portion includes a second protrusion protruding toward the one side in the circumferential direction;
the first protrusion in the first back yoke portion is located at a position overlapping the second protrusion in the second back yoke portion when the back yoke portion is viewed from the stacking direction; and
the first protrusion in the first back yoke portion is bonded to the second protrusion in the second back yoke portion.

4. The laminated core according to claim 3, wherein
the circumferential another-side separated portion in the first back yoke portion includes a first recess in which the first protrusion is positioned; and
the circumferential one-side separated portion in the second back yoke portion includes a second recess in which the second protrusion is positioned.

5. The laminated core according to claim 1, wherein the back yoke portion extends spirally about an axis of the laminated core and is stacked in the stacking direction.

6. The laminated core according to claim 5, wherein
the back yoke portion includes the first back yoke portion extending spirally about the axis and stacked in the stacking direction, and the second back yoke portion extending spirally about the axis and stacked adjacent in the stacking direction to the first back yoke portion stacked in the stacking direction;
the first back yoke portion includes a circumferential one-side separated portion located on one side in the circumferential direction with respect to the cut line, and a circumferential another-side separated portion located on the other side in the circumferential direction with respect to the cut line and in contact with the circumferential one-side separated portion in the circumferential direction;
the second back yoke portion includes a circumferential one-side separated portion located on one side in the circumferential direction with respect to the cut line, and a circumferential another-side separated portion located on the other side in the circumferential direction with respect to the cut line and in contact with the circumferential one-side separated portion in the circumferential direction;
the circumferential one-side separated portion in the first back yoke portion includes a first protrusion protruding toward the other side in the circumferential direction, and the circumferential another-side separated portion in the first back yoke portion includes a first recess in which the first protrusion is positioned;
the circumferential another-side separated portion in the second back yoke portion includes a second protrusion protruding toward the one side in the circumferential direction, and the circumferential one-side separated portion in the second back yoke portion includes a second recess in which the second protrusion is positioned;
the first protrusion in the first back yoke portion is located at a position overlapping the second protrusion in the second back yoke portion when the back yoke portion is viewed from the stacking direction; and
the first protrusion in the first back yoke portion is bonded to the second protrusion in the second back yoke portion.

7. The laminated core according to claim 5, wherein
one of the back yoke portions adjacent to each other in the stacking direction includes the cut line with a radially inner end located at a position overlapping a radially inner end of the cut line in the other of the back yoke portions adjacent to each other in the stacking direction when viewed from the stacking direction; and
the cut line in the one of the back yoke portions includes a radially outer end located at a position overlapping a radially outer end of the cut line in the other of the back yoke portions when viewed from the stacking direction.

8. The laminated core according to claim 7, wherein the back yoke portion includes an outer-peripheral-side recess recessed toward the inner peripheral side at a position radially outward of the radially outer end of the cut line in an outer peripheral surface of the back yoke portion.

9. A method for manufacturing a laminated core in which a back yoke portion in a plate shape and tooth portions in a plate shape are stacked in a thickness direction of the laminated core, the method comprising:
a punching step of punching a steel plate to form a back yoke forming portion extending in a first direction, the plurality of tooth portions extending from the back yoke forming portion toward one side in a second direction intersecting the first direction when the steel plate is viewed in its thickness direction, and a slit extending toward another side in the second direction between the tooth portions adjacent to each other in the first direction in the back yoke forming portion;
a back yoke bending step of forming the back yoke portion by bending the back yoke forming portion in an arc shape by closing a gap of the slit when the back yoke forming portion formed in the punching step is viewed in the thickness direction; and
a stacking step of bonding the back yoke portion bent in an arc shape in the back yoke bending step while the back yoke portions are stacked in a stacking direction; wherein
the punching step is performed to form the slit at a first position in one of two of the back yoke portions adjacent to each other in the stacking direction and form the slit at a second position in another one of the back yoke portions, the first position being different from the second position.

10. The method for manufacturing a laminated core according to claim 9, wherein
the slit includes a first slit including a first protrusion protruding toward another side in the first direction and a second slit including a second protrusion protruding toward one side in the first direction;
the punching step is performed to form not only the first slit in one of the back yoke portions adjacent to each other in the stacking direction, but also the second slit in another of the back yoke portions adjacent to each other in the stacking direction; and
the first protrusion of the first slit of one of the back yoke portions adjacent to each other in the stacking direction is bonded to the second protrusion of the second slit of the other of the back yoke portions adjacent to each other in the stacking direction while the back yoke portions bent in an arc shape in the back yoke bending step are stacked in the stacking direction.

11. The method for manufacturing a laminated core according to claim 10, wherein
the punching step includes a first punching step of punching a steel plate to form a first back yoke forming portion, a first plurality of the tooth portions, and the first slit, and a second punching step of punching the steel plate to form a second back yoke forming portion, second tooth portions, and the second slit;
the back yoke bending step includes a first back yoke bending step of forming a first back yoke portion by closing a gap of the first slit and bending the first back yoke forming portion in an arc shape when the first back yoke forming portion formed in the first punching step is viewed from the thickness direction, and a second back yoke bending step of forming a second back yoke portion by closing a gap of the second slit and bending the second back yoke forming portion in an arc shape when the second back yoke forming portion formed in the second punching step is viewed from the thickness direction; and
the stacking step is performed to alternately stack and bond the first back yoke portion bent in an arc shape in the first back yoke bending step and the second back yoke portion bent in an arc shape in the second back yoke bending step in the stacking direction.
